(19) United States
(12) Patent Application Publication
(10) Pub. No.: US 2017/0229707 A1
(43) Pub. Date: Aug. 10, 2017

(54) CATHODE COMPOSITIONS FOR LITHIUM-ION BATTERIES

(71) Applicant: 3M INNOVATIVE PROPERTIES COMPANY, St. Paul, MN (US)

(72) Inventors: Jeffrey R. Dahn, Nova Scotia (CA); Ramesh Shunmugasundaram, Tamilnadu (IN); Kevin W. Eberman, St. Paul, MN (US); Zhonghua Lu, Woodbury, MN (US)

(21) Appl. No.: 15/501,197

(22) PCT Filed: Aug. 5, 2015
(86) PCT No.: PCT/US15/43701

§ 371 Date: Feb. 2, 2017

Related U.S. Application Data
(60) Provisional application No. 62/033,383, filed on Aug. 5, 2014.

(51) Int. Cl. H01M 4/525; C01G 53/00; H01M 4/62; H01M 4/505; H01M 10/0525

(52) U.S. Cl. CPC H01M 4/525; H01M 4/505; H01M 10/0525; H01M 4/625; H01M 4/623; C01G 53/50; H01M 2004/028

(57) ABSTRACT

A cathode composition includes a lithium transition metal oxide having the formula Liₚ□_{q}NiₓMn_{y}Co_{z}O₂, where □ represents assumed vacancy content, p+q+x+y+z=2, 0.05<q<0.15, 0.8<p<1.02, 0.05<x<0.45, 0.05<y<0.6, 0.05<z<0.6, and 0.14<p*x<0.34. The lithium transition metal oxide has an O3 type structure.

### TECHNICAL FIELD

The present disclosure relates to compositions useful as cathodes for lithium-ion batteries.

### SUMMARY

In some embodiments, a cathode composition is provided. The cathode composition includes a lithium transition metal oxide having the formula

Liₚ□_{q}NiₓMn_{y}Co_{z}O₂,

where □ represents an assumed vacancy content, p+q+x+y+z=2, 0.05<q<0.15, 0.8<p<1.04, 0.05<x<0.45, 0.05<y<0.6, and 0.05<z<0.6. The lithium transition metal oxide has an O3 type structure. The irreversible capacity, when the composition is tested using a lithium metal foil as a counter electrode and a carbonate based electrolyte containing 1M LiPF6, is less than 15.5% between 2.0-4.8V vs Li using 10 mA/g at 30° C.

In some embodiments, a cathode composition is provided. The cathode composition includes a lithium transition metal oxide having the formula

Liₚ□_{q}NiₓMn_{y}Co_{z}O₂,

where □ represents an assumed vacancy content, p+q+x+y+z=2, 0.05<q<0.15, 0.8<p<1.02, 0.05<x<0.45, 0.05<y<0.6, 0.05<z<0.6, and 0.14<p*x<0.34. The lithium transition metal oxide has an O3 type structure.

In some embodiments, a method of making a lithium transition metal oxide cathode composition is provided. The method includes combining precursors having a formula (i) Ni_{x′}Mn_{y′}Co_{z′}CO₃; or (ii) Ni_{x′}Mn_{y′}Co_{z′}(OH)₂, where x′+y′+z′=1, and heating the precursors to form the lithium transition metal oxide.

The above summary of the present disclosure is not intended to describe each embodiment of the present disclosure. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIG. 1A illustrates voltage curves showing the first cycle voltage versus capacity for the samples described in Samples A1-3 (CE 1 and Ex 1-2) cycled between 4.8V and 2.0V.

FIG. 1B illustrates voltage curves showing the first cycle voltage versus capacity for the samples described in Samples B1-4 (CE 2 and Ex 3-5) cycled between 4.8V and 2.0V.

FIG. 1C illustrates voltage curves showing the first cycle voltage versus capacity for the samples described in Samples C1-5 (CE 3-5 and Ex 6-7) cycled between 4.8V and 2.0V.

FIG. 1D illustrates voltage curves showing the first cycle voltage versus capacity for the samples described in Samples D1-5 (CE 6-8 and Ex 8-9) cycled between 4.8V and 2.0V.

FIG. 1E illustrates voltage curves showing the first cycle voltage versus capacity for the samples described in Samples E1-2 (CE 9-10) cycled between 4.8V and 2.0V.

FIG. 1F illustrates voltage curves showing the first cycle voltage versus capacity for the samples described in Samples F1-3 (CE 11 and Ex 10-11) cycled between 4.8V and 2.0V.

FIG. 1G illustrates voltage curves showing the first cycle voltage versus capacity for the samples described in Samples G1-2 (CE 12 and Ex 12) cycled between 4.8V and 2.0V.

FIG. 1H illustrates voltage curves showing the first cycle voltage versus capacity for the samples described in Samples H1-3 (CE 13 and Ex 13-14) cycled between 4.8V and 2.0V.

FIG. 1I illustrates voltage curves showing the first cycle voltage versus capacity for the samples described in Samples I1-2 (CE 14 and Ex 15) cycled between 4.8V and 2.0V.

FIG. 1J illustrates voltage curves showing the first cycle voltage versus capacity for the samples described in Samples J1-2 (CE 15 and Ex 16) cycled between 4.8V and 2.0V.

FIG. 1K illustrates voltage curves showing the first cycle voltage versus capacity for the samples described in Samples K1-2 (CE 16 and Ex 17) cycled between 4.8V and 2.0V.

FIG. 1L illustrates voltage curves showing the first cycle voltage versus capacity for the samples described in Samples L1-2 (CE 17 and Ex 18) cycled between 4.8V and 2.0V.

FIG. 1M illustrates voltage curves showing the first cycle voltage versus capacity for the samples described in Samples M1-2 (CE 18 and Ex19) cycled between 4.8V and 2.0V.

FIG. 1N illustrates voltage curves showing the first cycle voltage versus capacity for the samples described in Samples N1-2 (CE 19 and Ex20) cycled between 4.8V and 2.0V.

FIG. 1O illustrates voltage curves showing the first cycle voltage versus capacity for the samples described in Samples O1-2 (CE 20 and Ex21) cycled between 4.8V and 2.0V.

FIGS. 2A-2C illustrate X-ray diffraction patterns for CE1 (A1) and EX 1-2 (A2-3), respectively.

FIGS. 2D-2F illustrate X-ray diffraction patterns for CE2 (B1) and EX 3-4 (B2-3), respectively.

FIGS. 2G-2I illustrate X-ray diffraction patterns for CE3-5 (C1-3), respectively.

FIGS. 2J-2L illustrate X-ray diffraction patterns for CE6-8 (D1-3), respectively.

FIGS. 3A and 3B illustrate the reversible specific capacity vs. vacancy content, and % irreversible capacity vs. vacancy content, respectively, for the exemplified samples of the present disclosure.

FIG. 4 is a ternary phase diagram for various known Ni—Mn—Co compositions as well as various Ni—Mn—Co compositions of the present disclosure.

### DETAILED DESCRIPTION

Lithium-ion batteries include a negative electrode, an electrolyte, and a positive electrode that contains lithium in the form of a lithium-transition metal oxide. Such lithium-transition metal oxide positive electrodes, or cathodes, may exhibit an O3 type structure in which the ratio of lithium to transition metal is greater than 1 (commonly referred to as “excess lithium”). Known O3 type structure cathode materials having excess lithium exhibit high discharge capacity, but also exhibit a large irreversible capacity at the end of the first charge-discharge cycle. Consequently, O3 type structure cathode materials that exhibit high discharge capacity and also low irreversible capacity at the end of the first charge-discharge cycle are desirable.

Heretofore, it has been suggested in the art that lithium deficient materials (i.e., materials that, on a molar basis, contain less lithium than would be present if site occupation and oxidation state rules were satisfied) are undesirable as cathode materials as a result of a propensity for transition metal atoms to move into sites in the lithium atom layer and block diffusion paths, leading to materials with low capacity and low rate capability. However, surprisingly and advantageously, it was discovered that certain lithium deficient O3 type structured cathode materials exhibit high discharge capacity but low irreversible capacity during the first cycle. In this regard, in some embodiments, the present disclosure is directed to a lithium deficient O3 structure-type cathode material. More specifically, the present disclosure is directed to a lithium deficient O3 structure-type cathode material that includes nickel, manganese, and cobalt. In various embodiments, the cathode materials of the present disclosure may exhibit irreversible capacities of less than 15%, 12%, 10%, 8%, 7% or lower of their first cycle charge capacity to 4.8 V when incorporated in a lithium-ion battery and cycled at 30° C. using a discharge current of 10 mA/g to 2.0V vs. Li.

As used herein, the phrase“O3 type structure” refers to a lithium metal oxide composition having a crystal structure consisting of alternating layers of lithium atoms, transition metal atoms and oxygen atoms. Among these layered cathode materials, the transition metal atoms are located in octahedral sites between oxygen layers, making an MO₂ sheet, and the MO₂ sheets are separated by layers of the alkali metals such as Li (e.g., layers generally arranged in the sequence lithium-oxygen-metal-oxygen-lithium). They are classified in this way: the structures of layered AₓMO₂ bronzes into groups (P2, O2, O6, P3, O3). The letter indicates the site coordination of the alkali metal A (prismatic (P) or octahedral (O)) and the number gives the number of MO₂ sheets (M transition metal) in the unit cell. The O3 type structure is generally described in Zhonghua Lu, R. A. Donaberger, and J. R. Dahn, Superlattice Ordering of Mn, Ni, and Co in Layered Alkali Transition Metal Oxides with P2, P3, and O3 Structures, Chem. Mater. 2000, 12, 3583-3590, which is incorporated by reference herein in its entirety. As an example, α-NaFeO₂ (R-3m) structure is an O3 type structure. Although some LiMO2 materials may exhibit ordering among the transition metals, reducing their symmetry to C2/m for example, these too have O3 type structure, because they meet the parameters of the description above. The terminology O3 type structure is also frequently used referring to the layered oxygen structure found in LiCoO₂.

As used herein, the phrase “assumed vacancy content” refers to a quantity of metal atom sites (e.g., transition metal atom sites and/or lithium metal atom sites) that are assumed to be unoccupied based on site occupation and oxidation state rules. The assumed vacancy content can be determined in accordance with the Assumed Vacancy Calculation Method described in the appended Examples.

As used herein, the phrase “irreversible capacity” means the percentage by which the first discharge capacity, D₁, is less than the first charge capacity, C₁. The irreversible capacity is calculated as [C₁−D₁]/C₁×100%.

As used herein, irreversible capacity values, when provided with respect to a cathode composition that includes a lithium transition metal oxide, assume test conditions that include a Li metal foil as a counter electrode and a carbonate based electrolyte containing 1M LiPF₆.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

In some embodiments, cathode compositions of the present disclosure may include Ni, Mn, and Co. The cathode compositions may include a lithium transition metal oxide having the general formula:

Liₚ□_{q}NiₓMn_{y}Co_{z}O₂ (I)

where □ represents the assumed vacancy content, and wherein the lithium transition metal oxide has an O3 type structure, p+q+x+y+z=2, and (i) 0.05<q<0.15; 0.8<p<1.04; 0.05<x<0.45; 0.05<y<0.6; and 0.05<z<0.6, and the irreversible capacity is less than 15.5% between 2.0-4.8V vs. Li using 10 mA/g at 30° C.; (ii) 0.06<q<0.15, 0.88<p<1.01; 0.1<x<0.45, 0.05<y<0.6, and 0.05<z<0.5, and the irreversible capacity is less than 10% between 2.0-4.8V vs. Li using 10 mA/g at 30° C.; or (iii) 0.06<q<0.14, 0.88<p<1.01, 0.1<x<0.4, 0.05<y<0.6, and 0.05<z<0.35, and the irreversible capacity is less than 8% between 2.0-4.8V vs. Li using 10 mA/g at 30° C.

In various embodiments, the cathode compositions may include a lithium transition metal oxide having general formula I, where □ represents the assumed vacancy content, and wherein the composition has an O3 type structure, p+q+x+y+z=2, and (i) 0.05<q<0.15, 0.8<p<1.02, 0.05<x<0.45, 0.05<y<0.6, 0.05<z<0.6, and 0.14<p*x<0.34; (ii) 0.075<q<0.15, 0.88<p<1.01, 0.1<x<0.45, 0.05<y<0.6, 0.05<z<0.42, and 0.14<p*x<0.34; or (iii) 0.087<q<0.14, 0.8<p<1.01, 0.1<x<0.4, 0.05<y<0.6, 0.05<z<0.35, and 0.14<p*x<0.34.

In some embodiments, the compositions of the present disclosure have the formulae set forth above. The formulae themselves reflect certain criteria that have been discovered and are useful for maximizing performance. Further, to maximize rapid diffusion in the lithium layers, and thus battery performance, the presence of transition metal elements in the lithium layers may be minimized. Still further, in various embodiments, at least one of the metal elements may be oxidizable within the electrochemical window of the electrolyte incorporated in the battery.

In various embodiments, the lithium transition metal oxides may optionally include one or more dopants. As used herein, the term “dopants” refers to metal element additives other than lithium, nickel, manganese, or cobalt. The dopant(s), in some embodiments, can be selected from transition metals, Group 13 elements of the periodic table, or combinations thereof. In another embodiment, the dopant(s) can be selected from transition metals, aluminum, and combinations thereof. In some embodiments, the transition metal can be selected from titanium, vanadium, chromium, copper, zirconium, niobium, molybdenum, iron, tungsten, and combinations thereof. Typical useful dopant levels are between 0 and 20%, or between 0 and 10% based on the total transition metal content.

In illustrative embodiments, specific examples of cathode compositions may include those having lithium transition metal oxides having any of the following formulae: Li_{0.997 0.1}Ni_{0.153}Mn_{0.443}Co_{0.309}O₂, Li_{0.944 0.136}Ni_{0.156}Mn_{0.451}Co_{0.313}O₂, Li_{1.01 0.084}Ni_{0.179}Mn_{0.45}Co_{0.277}O₂, Li_{0.998 0.091}Ni_{0.181}Mn_{0.451}Co_{0.279}O₂, Li_{1.003 0.09}Ni_{0.179}Mn_{0.451}Co_{0.279}O₂, Li_{0.964 0.087}Ni_{0.282}Mn_{0.474}Co_{0.192}O₂, Li_{0.984 0.062}Ni_{0.318}Mn_{0.474}Co_{0.162}O₂, Li_{0.964 0.078}Ni_{0.317}Mn_{0.479}Co_{0.161}O₂, Li_{0.919 0.098}Ni_{0.376}Mn_{0.506}Co_{0.102}O₂, Li_{0.886 0.122}Ni_{0.378}Mn_{0.512}Co_{0.103}O₂, Li_{1.00 0.094}Ni_{0.266}Mn_{0.547}Co_{0.093}O₂, Li_{0.928 0.111}Ni_{0.192}Mn_{0.38}Co_{0.39}O₂, Li_{0.873 0.114}Ni_{0.205}Mn_{0.292}Co_{0.516}O₂, Li_{0.915 0.119}Ni_{0.097}Mn_{0.282}Co_{0.588}O₂, Li_{1.003 0.09}Ni_{0.179}Mn_{0.451}Co_{0.279}O₂, Li_{0.957 0.1}Ni_{0.155}Mn_{0.368}Co_{0.421}O₂, Li_{0.936 0.115}Ni_{0.153}Mn_{0.371}Co_{0.424}O₂, Li_{1.02 0.102}Ni_{0.176}Mn_{0.522}Co_{0.18}O₂, Li_{1.017 0.132}Ni_{0.167}Mn_{0.597}Co_{0.087}O₂, Li_{0.871 0.119}Ni_{0.301}Mn_{0.399}Co_{0.31}O₂, Li_{0.956 0.119}Ni_{0.093}Mn_{0.36}Co_{0.472}O₂.

The present disclosure further relates to methods of making the above-described cathode compositions. In various embodiments, the cathode compositions of the present disclosure may be synthesized by milling together sources of the metals or by combining precursors of the metal elements, followed by heating in the presence of a lithium-containing material (e.g., Li₂CO₃) to generate the cathode composition. Heating may be conducted in air at temperatures of at least about 600° C., at least 800° C., or at least 900° C.

In some embodiments, the heating process may be conducted in air, which obviates the need and associated expense of maintaining a special atmosphere.

In various embodiments, the cathode materials of the present disclosure may be produced from precursors having the formula: (i) Ni_{x′}Mn_{y′}Co_{z′}CO₃; or (ii) Ni_{x′}Mn_{y′}Co_{z′}(OH)₂, where x′+y′+z′=1, which may or may not be partially oxidized or hydrated. Lithium-transition metal oxides produced from such precursors in air at about 600-1200° C. can be prepared such that the oxidation state of nickel will be 2+, the oxidation state of manganese will be 4+, and the oxidation state of cobalt will be 3+ in the final material. In such materials, there may be a need for lithium atoms to occupy sites in the transition metal layers in order to satisfy site occupation and oxidation state rules or for metal sites to be vacant, leading to final materials having the general formula (I) above. If q=0, to satisfy site occupation and oxidation state rules, the number of moles of lithium is p/(2−p) to add to one mole of Ni_{x′}Mn_{y′}Co_{z′}CO₃ precursor or Ni_{x′}Mn_{y′}Co_{z′}(OH)₂ precursor to make a composition according to general formula (I), where p=(4y′+2z′)/(1+2y′+z′) and x=x′(2−p), y=y′(2−p) and z=z′(2−p); i.e.

(p/(2−p))(½)Li₂CO₃+Ni_{x′}Mn_{y′}Co_{z′}CO₃+bO₂ [symbol] (1/(2−p))LiₚNiₓMn_{y}Co_{z}O₂+((4−p)/(4−2p))CO₂, where b=((12−5p)/(8−4p))−3/2.

However, in accordance with the present disclosure, to prepare materials with low irreversible capacity and high reversible capacity, less lithium on a molar basis may be added, i.e. p<(4y′+2z′)/(1+2y′+z′) and precursors where x′+y′+z′=1, 0.05<x′(2−p)<0.45, 0.05<y′(2−p)<0.6 and 0.05<z′(2−p)<0.6 may be selected. Without being bound by theory, it is believed that the presence of vacancies (i.e., the assumed vacancy content) contributes to the observed low irreversible capacities. Further, it was observed that if q is less than 0.05, irreversible capacity is generally greater than 15%; and if q is greater than 0.15, impurity phases can form and deleteriously impact reversible capacity. Thus, a range for the value of q has been identified as 0.05<q<0.15.

In some embodiments, to make a cathode from the cathode compositions of the present disclosure, the cathode composition and selected additives such as binders (e.g., polymeric binders), conductive diluents (e.g., carbon), fillers, adhesion promoters, thickening agents for coating viscosity modification such as carboxymethylcellulose or other additives known by those skilled in the art can be mixed in a suitable coating solvent such as water or N-methylpyrrolidinone (NMP) to form a coating dispersion or coating mixture. The coating dispersion or coating mixture can be mixed thoroughly and then applied to a foil current collector by any appropriate coating technique such as knife coating, notched bar coating, dip coating, spray coating, electrospray coating, slot-die, or gravure coating. The current collectors can be thin foils of conductive metals such as, for example, copper, aluminum, stainless steel, or nickel foil. The slurry can be coated onto the current collector foil and then allowed to dry in air followed by drying in a heated oven, typically at about 80° C. to about 300° C. for about an hour to remove all of the solvent.

The present disclosure further relates to lithium-ion batteries. In some embodiments, the cathode compositions of the present disclosure can be combined with an anode and an electrolyte to form a lithium-ion battery. Examples of suitable anodes include lithium metal, carbonaceous materials, silicon alloy compositions, and lithium alloy compositions. Exemplary carbonaceous materials can include synthetic graphites such as mesocarbon microbeads (MCMB), SLP30 (available from TimCal Ltd., Bodio Switzerland), natural graphites and hard carbons. Useful anode materials can also include alloy powders or thin films. Such alloys may include electrochemically active components such as silicon, tin, aluminum, gallium, indium, lead, bismuth, and zinc and may also comprise electrochemically inactive components such as iron, cobalt, metal oxides, metal silicides and metal aluminides.

The lithium-ion batteries of the present disclosure can contain an electrolyte. Representative electrolytes can be in the form of a solid, liquid or gel. Exemplary solid electrolytes include polymeric media such as polyethylene oxide, polytetrafluoroethylene, polyvinylidene fluoride, fluorine-containing copolymers, polyacrylonitrile, combinations thereof and other solid media that will be familiar to those skilled in the art. Examples of solid electrolytes further include ceramic or glass materials, such as Li₁₀GeP₂S₁₂, Li₂S—SiS₂—Li₃PO₄ and Li₇P₃S₁₁. Examples of liquid electrolytes include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, .gamma.-butylrolactone, methyl difluoroacetate, ethyl difluoroacetate, dimethoxyethane, diglyme (bis(2-methoxyethyl) ether), tetrahydrofuran, dioxolane, combinations thereof and other media that will be familiar to those skilled in the art. The electrolyte can be provided with a lithium electrolyte salt. The electrolyte can include other additives that will familiar to those skilled in the art.

In some embodiments, lithium-ion batteries of the present disclosure can be made by taking at least one each of a positive electrode and a negative electrode as described above and placing them in an electrolyte. A microporous separator, such as CELGARD 2400 microporous material, available from Celgard LLC, Charlotte, N.C., may be used to prevent the contact of the negative electrode directly with the positive electrode.

In various embodiments, the cathode compositions of the present disclosure, when incorporated into a lithium-ion battery, may exhibit discharge capacities commensurate with known O3 type structure cathode materials. For example, the cathode compositions of the present disclosure, when incorporated into a lithium-ion battery, may exhibit discharge capacities of higher than 220 mAh/g. Furthermore, the cathode compositions of the present disclosure, when incorporated into a lithium-ion battery, may exhibit irreversible capacities that are lower than that of known O3 type structure cathode materials. For example, the cathode materials of the present disclosure may exhibit irreversible capacities of 15%, 12%, 10%, 8%, 7% or lower of their first cycle charge capacity to 4.8 V when incorporated in a lithium-ion battery and cycled at 30° C. using a discharge current of 10 mA/g.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### Examples

Sample Preparation

### Comparative Example 1 (CE 1; Sample A1)

43.81 g of NiSO₄.6H₂O (Sigma-Aldrich, ACS reagent 99%), 84.51 g of MnSO₄.H₂O (Sigma-Aldrich ACS, reagent 98%), and 93.70 g of CoSO₄.7H₂O (Sigma-Aldrich, ACS Reagentplus ≧99%) were dissolved in distilled water and made up to 500 mL of mixed transition metal aqueous solution. In a separate beaker, 106.20 g of Na₂CO₃ (Sigma-Aldrich, ACS reagent, anhydrous, ≧99.5%) was dissolved in distilled water and made up to 500 mL of aqueous solution. Approximately 0.1 M NH₄OH aqueous solution was prepared by dissolving ˜3.35 mL of stock solution (Sigma-Aldrich, equivalent to 28.0% w/w NH₃) in distilled water and made up to 500 mL. The prepared ammonium hydroxide aqueous solution was used as an initial reaction medium in a continuously-stirring tank reactor (CSTR). The prepared aqueous solutions of mixed transition metals and Na₂CO₃ solution were fed into the CSTR using digital peristaltic pumps (Masterflex L/S 07524) at a flow rate of approximately 0.333 mL per min and were allowed to precipitate gradually. The stirring in the CSTR was set at 500 rpm whereas the temperature and the pH of the reaction were set to 60° C. and 8.0 respectively. The coprecipitation reaction resulted in the formation of a mixed transition metal carbonate of the formula Ni(II)_{0.167}Mn(II)_{0.5}Co(II)_{0.333}CO₃. After the completion of the coprecipitaton reaction, the suspension was recovered, washed several times with distilled water and filtered. The wet precipitate was then dried at approximately 100° C. for about 12 hours in a box furnace.

The amount of Li₂CO₃ and Ni(II)_{0.167}Mn(II)_{0.5}Co(II)_{0.333}CO₃ precursor for the synthesis of the target composition Lil_{1.143}Ni_{0.143}Mn_{0.428}Co_{0.286}O₂ (Sample A1; CE1) was calculated as follows:

| | Reaction | | | | |
|---|---|---|---|---|---|
| | 0.857 Ni(II)_{0.167}Mn(II)_{0.5}Co(II)_{0.333}CO₃ + 0.571 Li₂CO₃ + 0.286 O₂ = Li_{1.143}Ni_{0.143}Mn_{0.428}Co_{0.286}O₂ + 1.429 CO₂ | | | | |
| | Ni(II)_{0.167}Mn(II)_{0.5}Co(II)_{0.333}CO₃ | Li₂CO₃ | O₂ | Li_{1.143}Ni_{0.143}Mn_{0.428}Co_{0.286}O₂ | CO₂ |
| Molar mass | 116.89 | 73.89 | Supplied | 88.70 | Exhausted |
| (g/mol) | | | from air | | to air |
| Stoichiometric | 100.195 | 42.223 | | 88.700 | |
| Mass balance | | | | | |
| (grams per | | | | | |
| one mole of | | | | | |
| final lithium | | | | | |
| transition | | | | | |
| metal oxide) | | | | | |
| Required | 5.648 | 2.380 | | 5 | |
| mass for 5 g | | | | | |
| product (g) | | | | | |

5.6480 g of Ni(II)_{0.167}Mn(II)_{0.5}Co(II)_{0.333}CO₃ precursor and 2.4991 g (2.38 gram of Li₂CO₃ plus about 5 wt % excess for compensating Li loss due to evaporation during sintering) of Li₂CO₃ were weighed accurately, mixed and ground well using a mortar and pestle. The mixed powders were loaded in an alumina crucible and calcinated in air using a box furnace to yield the positive electrode material. The following heating and cooling profile was used during the firing: step 1—Heating from room temperature to 400° C. at 10° C. per minute and hold for 2 hours, step 2—heating from 400° C. to 900° C. at 10° C. per minute and hold for 12 hours, and step 3—cooling down to room temperature at 2° C. per minute.

### Preparation of Comparative Examples 2-20 and Examples 1-21

Comparative examples 2-20 and examples 1-21 were synthesized similarly to CE1 (sample A) described above. Table 1 below shows the example or comparative example number; sample identifier; precursor composition; target composition; moles of lithium required for target composition; number of moles of lithium added including 5% excess; Li:Ni:Mn;Co ratio as determined from ICP-OES; and composition with calculated vacancy content using equations 3-7.

Determination of Metal Atom Ratios in Samples Using ICP-OES

The Li, Mn, Ni and Co content of the oxide powders was obtained using inductively coupled plasma optical emission spectroscopy (ICP-OES) performed at the Minerals Engineering Centre at Dalhousie University. Approximately 10 mg of each sample was dissolved in a 3:1 reagent grade HCl:HNO₃ (aqua regia) solution which was then diluted to 50 mL prior to measurement. For each sample, elemental compositions were reported as mass fractions of Li, Mn, Ni and Co relative to the total solution mass in units of mg kg⁻¹, with a 2% relative error for each mass fraction. From these results, the atomic ratios of Li:Ni:Mn:Co listed in Table 1 were obtained.

Assumed Vacancy Calculation Method

The metal atom ratios Li:Ni:Mn:Co from ICP-OES listed in Table 1 were taken to accurately describe each sample. The ratios are represented by the variables p′, a, b, and c, respectively. The values p′, a, b, and c in Table 1 have been scaled so that their sum is exactly 2.0. After heating, it is assumed that the final compound is Liₚ□_{q} NiₓMn_{y}Co_{z}O₂, where:

p+q+x+y+z=2 Eqn. 1

and

p+2x+4y+3z=4. Eqn. 2

These equations result from a filling of all metal sites by Li, Ni, Mn, Co or vacancies (Eqn. 1) and from charge balance, assuming Li⁺, Ni²⁺, Mn⁴⁺ and Co³⁺ (Eqn. 2), respectively. The metal atom ratios as determined by ICP-OES must match those in Liₚ□_{q}NiₓMn_{y}Co_{z}O₂, leading to the equations:

x=a(2−q)/2, Eqn. 3

y=b(2−q)/2, Eqn. 4

z=c(2−q)/2 Eqn. 5

and

p=p′(2−q)/2 Eqn. 6

Equations 2-6 can be used to solve for q, the assumed vacancy content of the resulting layered material. One obtains:

q=2−8/A, where A=p′+2a+4b+3c Eqn. 7.

When the calculated q<0, it is believed that there is no any metal vacancy in the structure. However, instead, it is believed that a small of amount of Ni is in 3+ oxidation state. It is our belief that Ni³⁺ and metal vacancy could not exist at the same structure.

Table 1 lists the compositions of the samples A1 to 02 (comparative examples CE1 to CE 20 and examples EX1 to EX 21) as Liₚ□_{q}NiₓMn_{y}Co_{z}O₂. The assumed vacancy content, q of each sample can be thus determined from Table 1. In some cases, p turned out to be less than 1, which would indicate some vacancies in the Li layer. Without being bound by theory, it is submitted that the calculations above suggest that metal atom vacancies exist in these samples. However, it has not been definitely proven that vacancies actually exist in these samples. Rather, the assumed vacancy content has been used to demonstrate a strong correlation between irreversible capacity and q, calculated in this manner.

Electrochemical Cell Preparation

The working electrodes were made from the positive electrode materials (A1 to O2; see Table 1). About 90 wt % (˜1.8 g) of the positive electrode material was mixed with 5 wt % (˜0.1 g) of carbon black Super C45 (commercially available from TIMCAL), 5 wt % (˜0.1 g) of polyvinylidene difluoride (PVDF) binder (commercially available from ARKEMA) and about 2.4 g of N-methyl pyrrolidone (NMP) solvent. Two zirconia beads of diameter 8 mm were added to the whole mixture and shaken well in a mixer (Mazerustar) for about 20 minutes to get uniform slurry.

The freshly prepared slurry was spread into a film on an aluminum foil using a notch-bar (0.006″ or 0.1524 mm gap). After drying at least for 3 hours at 120° C. to completely remove the NMP, the dried electrode was pressed using a calendar roller with a pressure of 200 bar (20 megapascal). The compressed electrode sheet was punched using an electrode punch into several circular disks of 1.3 cm diameter, which were eventually used as working electrodes in the coin cells. The circular disk electrodes were weighted accurately and from which the active mass was calculated.

The cell assembly was carried out in an Argon-filled glovebox. A casing is placed at the bottom with the positive electrode (working electrode). A circular lithium foil serves as the reference electrode as well the negative electrode. Two layers of microporous separators made of microporous polypropylene (Celgard) were placed on top of the positive electrode before placing the lithium foil to prevent short circuit. About 10 drops of electrolyte solution made up of 1 M lithium hexafluorophosphate (LiPF₆) in 1:2 ethylene carbonate (EC)/diethyl carbonate (DEC) (commercially available from Novolyte technologies) was placed between the positive and negative electrodes to enable the diffusion of Li+ through the electrolyte during charge/discharge. A spacer and a disk spring were placed on top of the lithium foil before the casing top and gasket were placed. The arranged stack was carefully compressed using an argon-controlled crimper to seal the electrochemical coin cells.

Electrochemical Cell Cycling

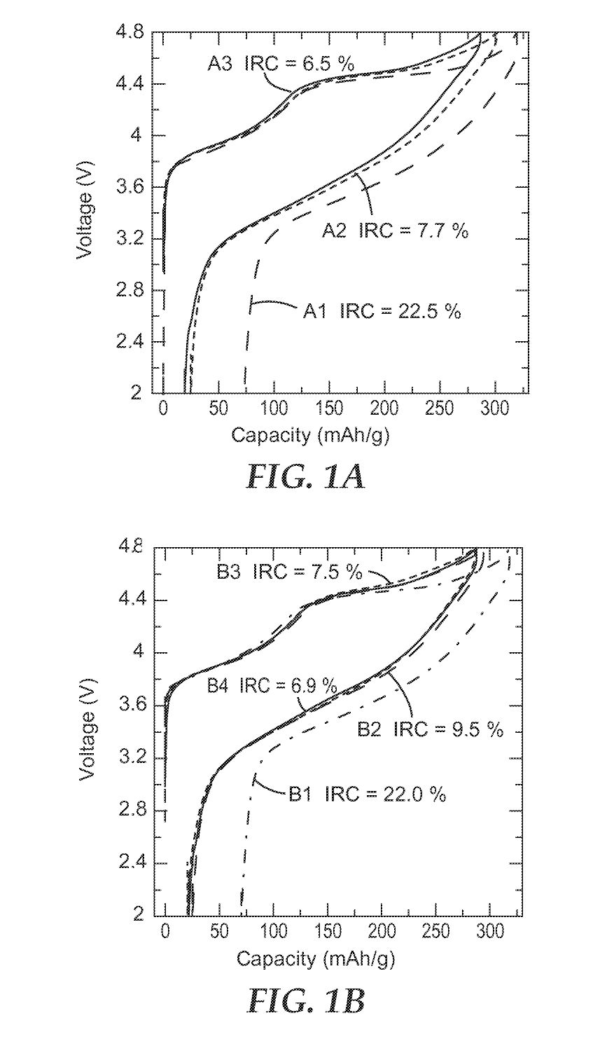

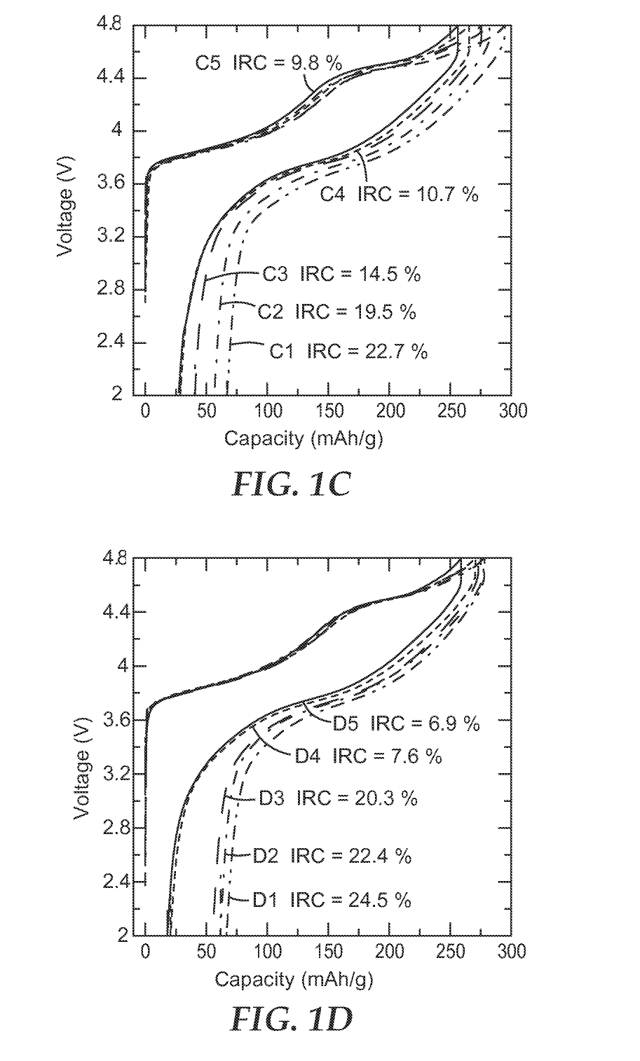

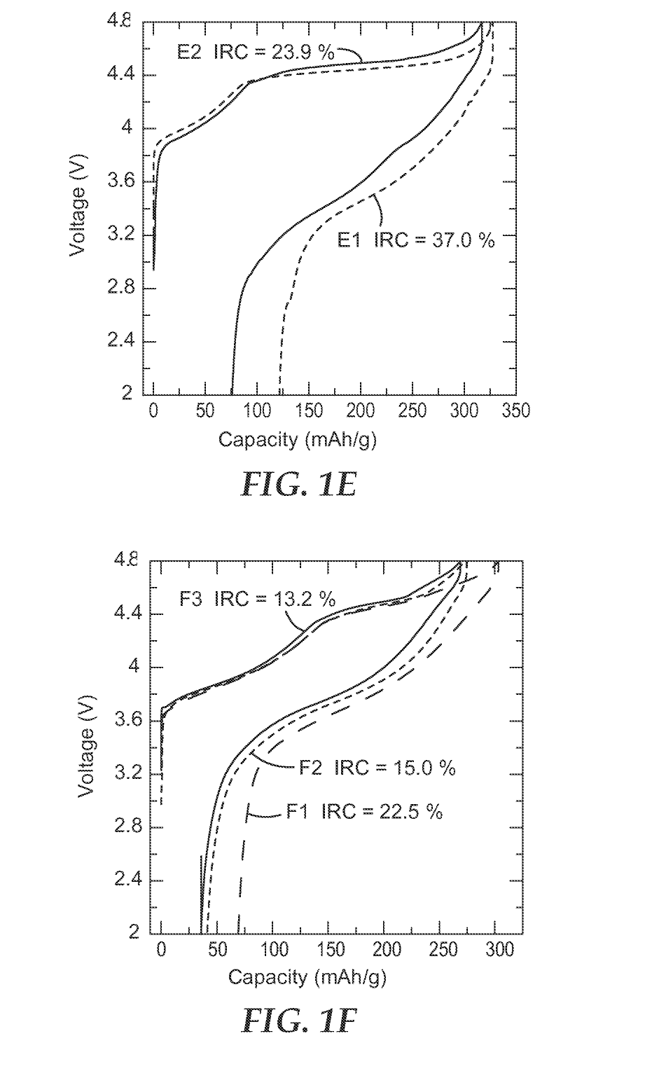

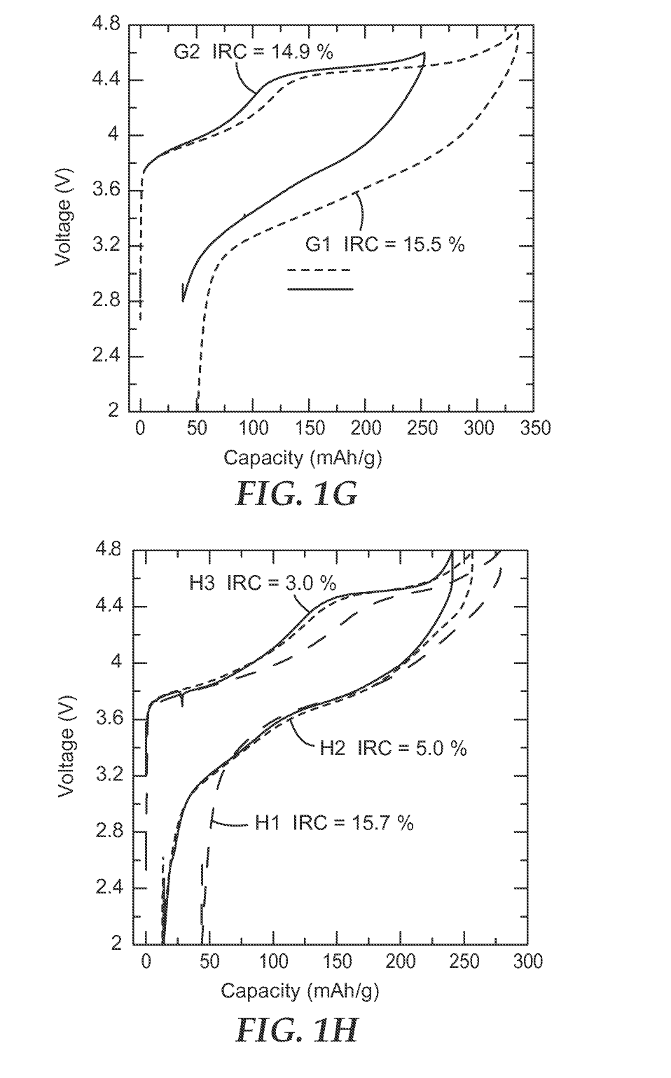

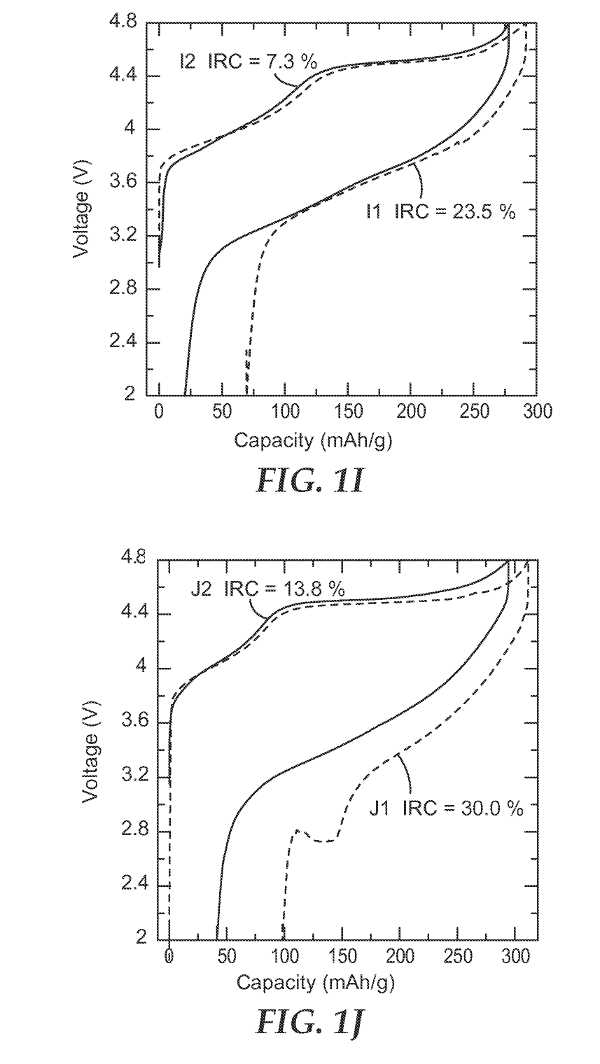

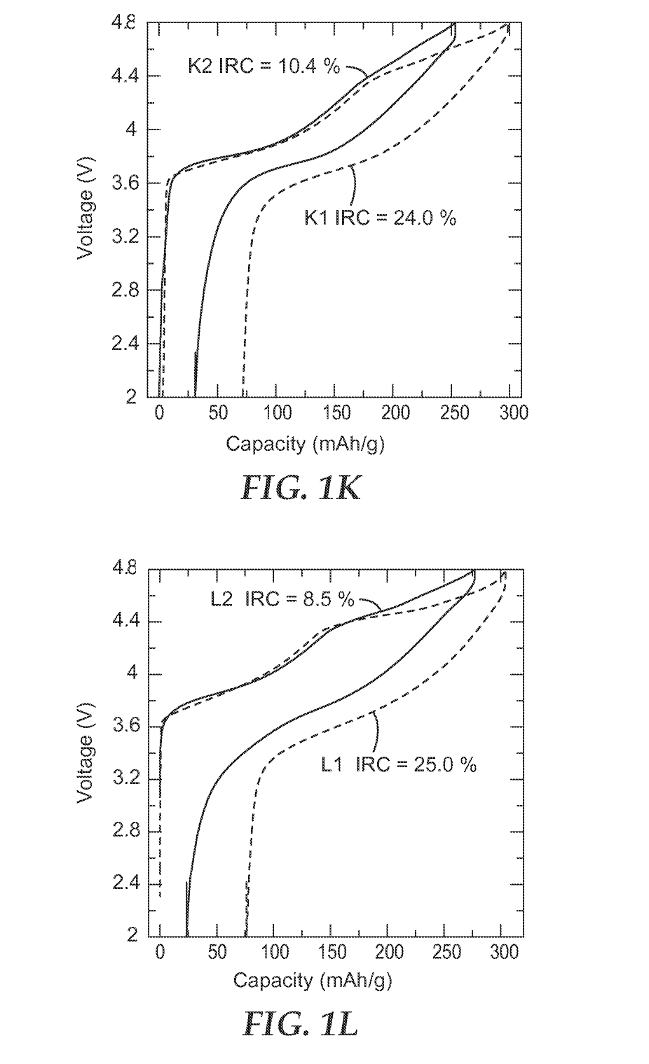

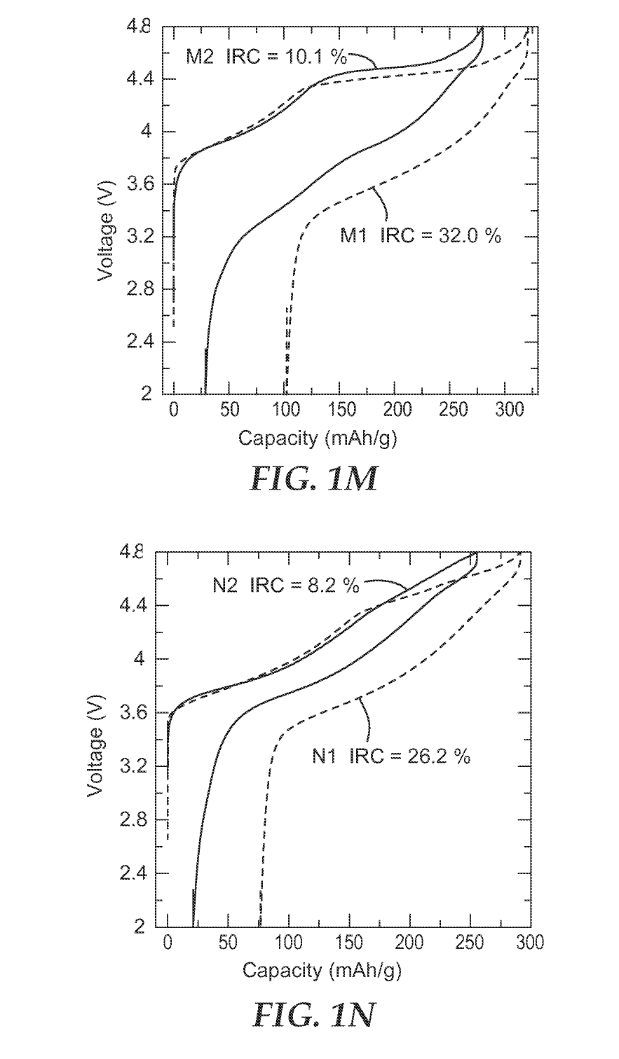

All the constructed electrochemical coin cells were galvanostatically under a current density of 10 mA/g at 30° C. using a computer-controlled charger system (Maccor 4000). The first charge-discharge cycle was between 4.8 V and 2.0 V and the subsequent cycles were between 4.6 V and 2.8 V under the same current density and temperature. The voltage vs. specific capacity curves for all the electrode compositions (A1-02) were measured and are shown in FIG. 1A-1O. Using these cycling curves, the reversible capacity, % irreversible capacity and cell fade were determined and listed in Table 2. The reversible capacity reported came from the first discharge from 4.8V to 2.0V. The irreversible capacity (IRC), shown as the % of the first cycle charge capacity was determined by {specific capacity obtained during first cycle charge up to 4.8 V}−{specific capacity obtained during first cycle discharge to 2.0 V}/{specific capacity obtained during first cycle charge up to 4.8 V}*100%. The fade was determined from {Reversible capacity from Cycle #6}−{Reversible capacity from Cycle #20}/{Reversible capacity from Cycle #6}.

The cycling data in Table 2 show Samples A2, A3, B2, B3, B4, C5, D4, D5, H2, H3, I2, L2, N2 and O2 as examples had irreversible capacities less than 10%. Additionally, samples C4, F2, F3, G2, J2, K2 and M2 had irreversible capacities less than or equal to 15%. Target compositions assume no vacancies and make no assumption regarding the transition metal oxidation states. However, the first target composition in each sample set (i.e. A1, B1, C1, . . . ) satisfies the oxidation state rules Ni⁺², Mn⁺⁴, Co³⁺, with no vacancies. The subsequent target compositions in each set were prepared with a lower Li₂CO₃ to precursor ratio (lithium deficient), and all of the samples with <15% irreversible capacity are in this category, and furthermore all have q<0.05.

X-Ray Diffraction and Lattice Constants

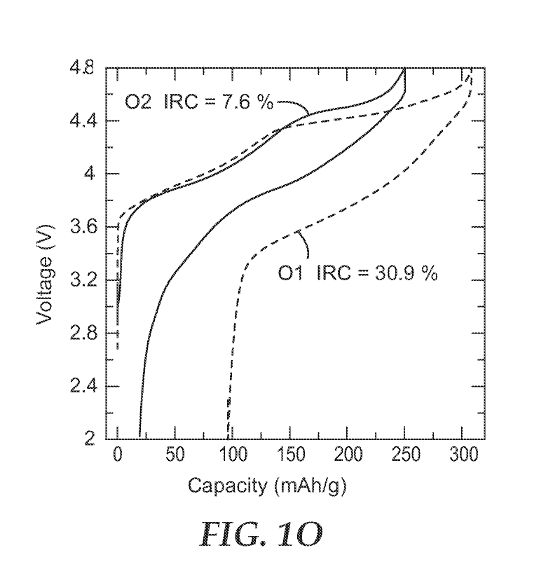

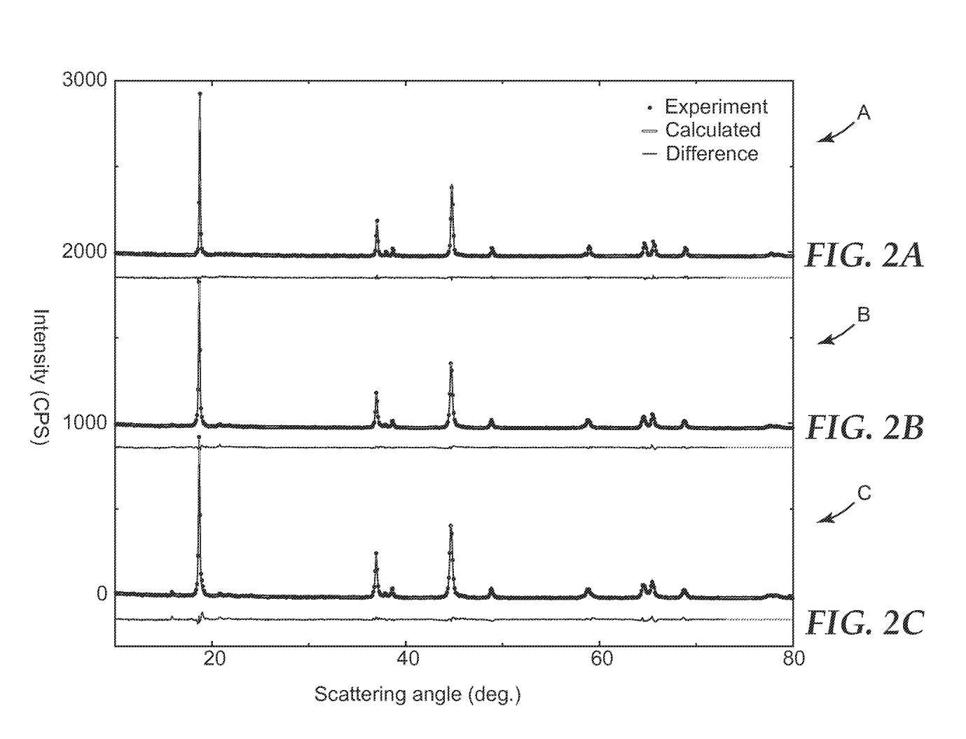

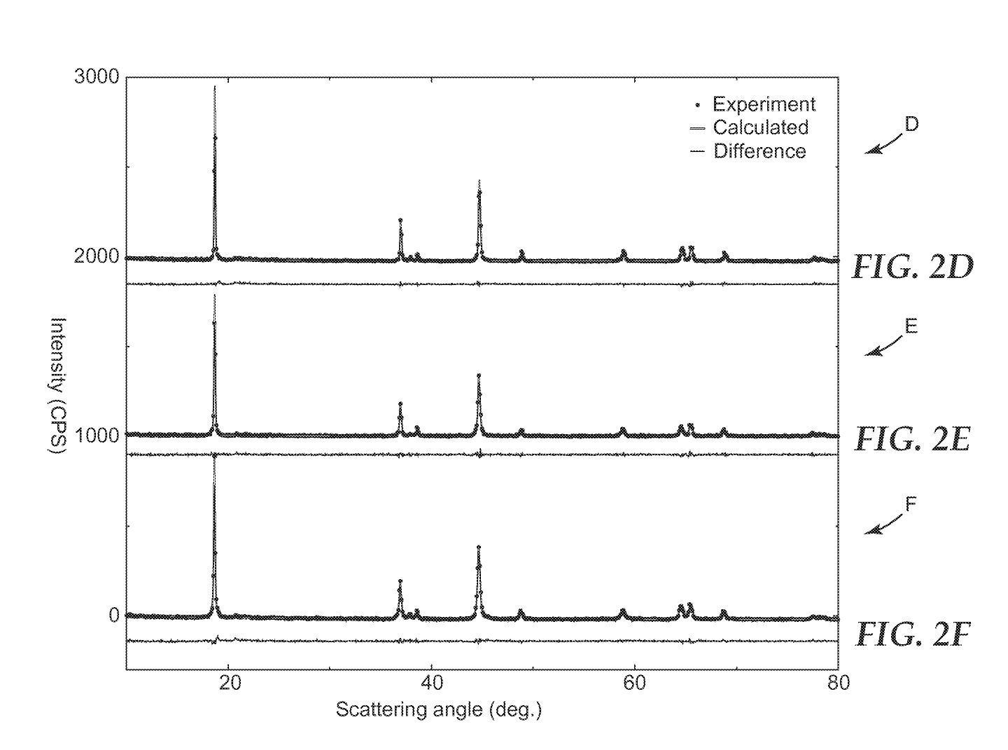

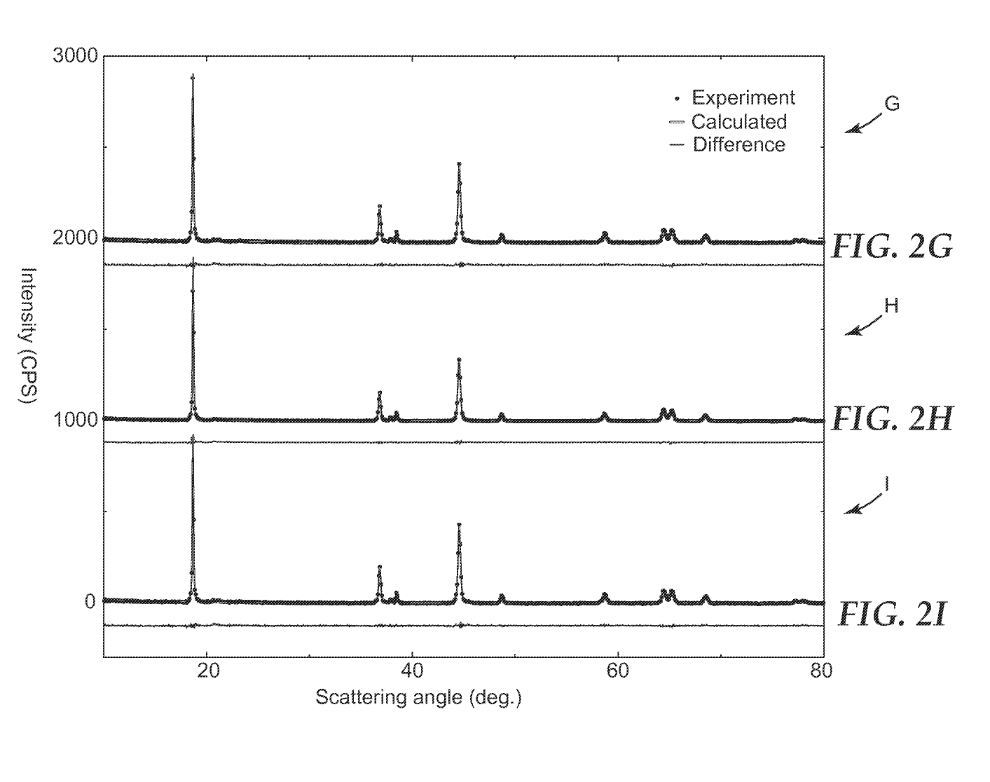

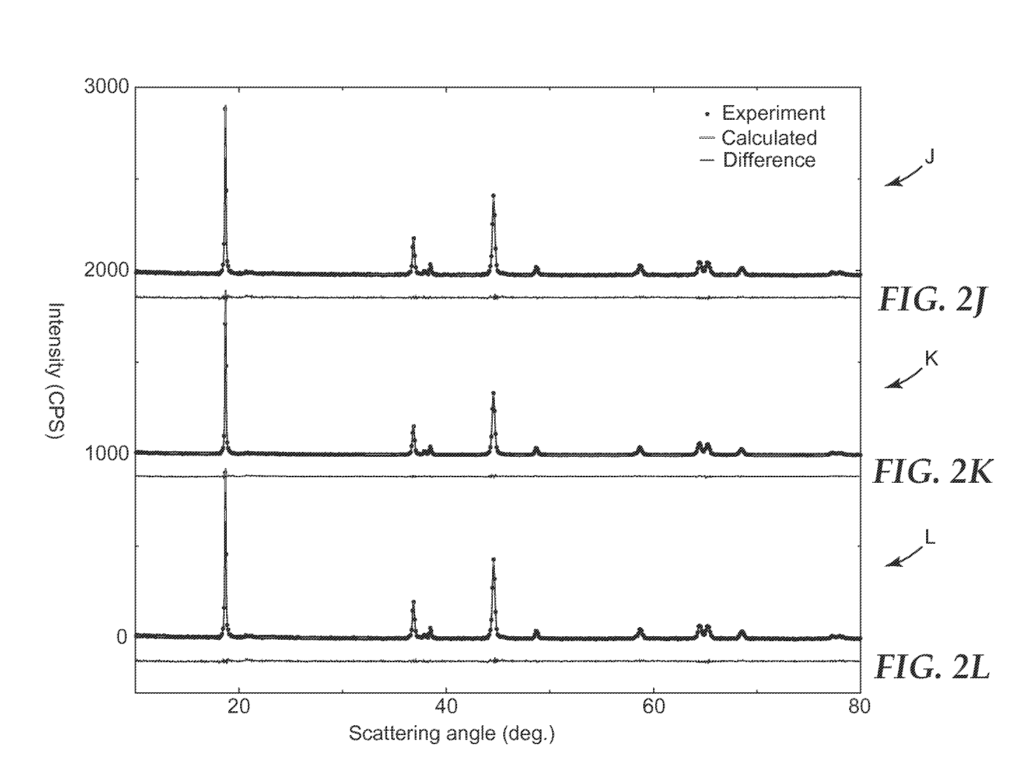

A powder x-ray diffraction pattern for each sample (A1-O2) was collected using a Siemens D5000 diffractometer equipped with a copper target x-ray tube and a diffracted beam monochromator. Data was collected between scattering angles of 10 degrees and 90 degrees 2.theta. The crystal structure of each sample could be described well by the O3 crystal structure type. Lattice parameters were determined using the Rietveld refinement and are listed in Table 3. An X-ray pattern fitting program called “Rietica” was used for Rietveld refinement. The refinement was carried out by minimizing the sum of the weighted, squared difference between the calculated and the experimental XRD intensities. All the studied samples had layered structures and each structure was refined by considering a hexagonal lattice with R-3M space group. Each element in the structure was represented as atoms in their respective sites. The atomic coordinates of the sites in the transition metal layer, Li layer and oxygen layer were taken as (0, 0, 0), (0, 0, ½) and (0, 0, z) with z˜¼, respectively. The overall temperature factor, β, was set to 0.6 in the Rietica software. The Bragg peak shape was represented using a pseudo-Voigt function. Selected XRD patterns are shown in FIGS. 2A-2L. The agreement between data and calculated curve is very good in all cases. Thus, the lattice constants in Table 3 are reliable.

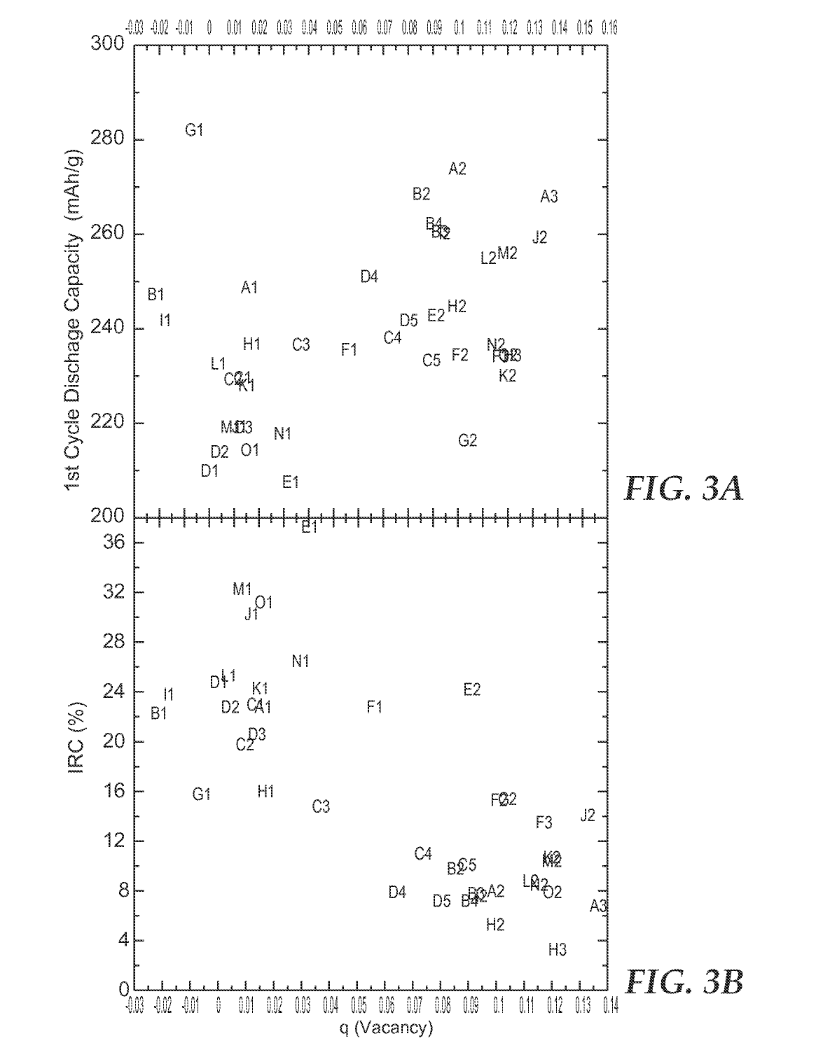

FIG. 3 shows % irreversible capacity plotted versus the vacancy content, q, (lower panel) and reversible specific capacity plotted versus the vacancy content, q (upper panel). FIG. 3 shows that attractive materials, with low irreversible capacity, exist when 0.05<q<0.15 and q is calculated from the measured metal atom ratios using equations 1-7.

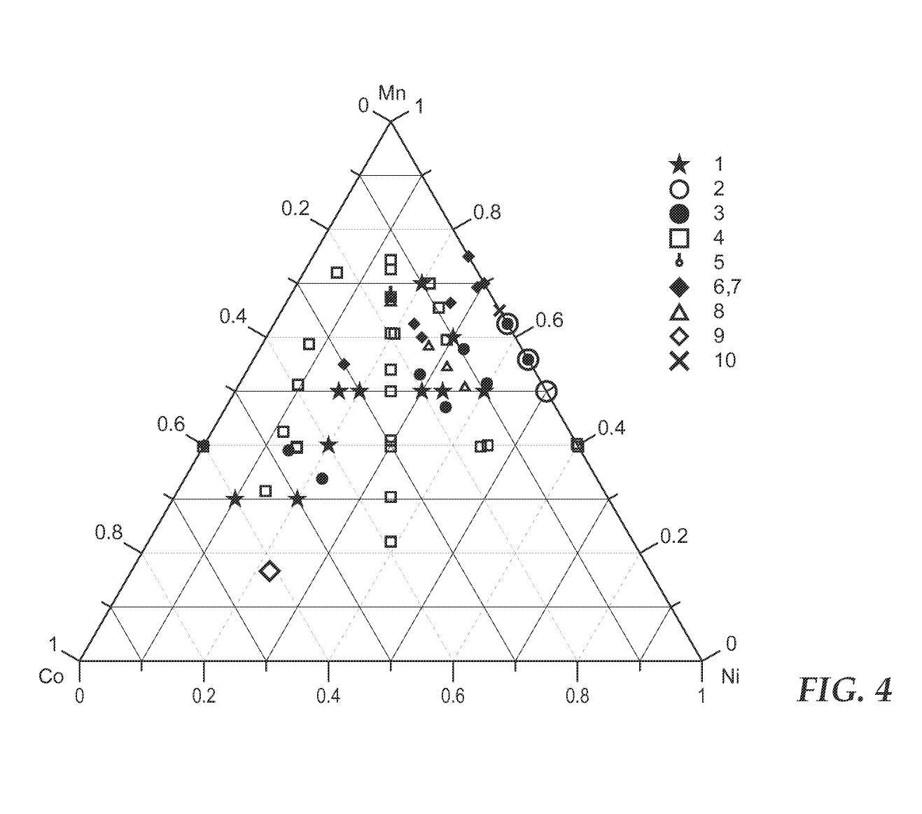

Without being bound by theory, the results suggest that vacancies are created on the metal atom sites when insufficient lithium on a molar basis is added to the precursors. Numerous researchers have studied Li-rich Li transition metal oxides in the past and have measured irreversible capacity. FIG. 4 shows the composition of precursors studied in the literature as well as the samples prepared for the present disclosure (symbol 1). The different symbols on the diagram represent precursors prepared in the literature references as indicated in the legend. Even though there is substantial overlap between the transition metal precursor compositions in the present disclosure and for the literature, the literature samples did not attain low irreversible capacity as shown in Table 3. All literature samples had irreversible capacities much greater than 10%, except for the sample reference 10 which did not have Co included. This is believed to be because the literature samples were not designed to have lithium deficiency, and thus did not have 0.05<q<0.15.

TABLE 1
Example or comparative example number, sample identifier, precursor composition, target composition, moles of lithium required for actual target composition, number
of moles of lithium added including 5% excess, atomic ratios of Li:Ni:Mn:Co as determined using ICP-OES, and composition with calculated assumed vacancy content.

| | | | | | No. of moles of Li | | |
|---|---|---|---|---|---|---|---|
| | | Nominal | | No. of moles of Li | originally added including | | Composition of |
| Example (Ex) | | Precursor | | required to get a | extra 5% for compensating | ICP-OES | a formula unit with |
| or Comp. | | Composition | Target | formula unit of | Li loss to get a formula | Li:Ni:Mn:Co = | calculated vacancy |
| Example (CE) | Sample | Ni_{x′}Mn_{y′}Co_{z′} | Composition | target composition | unit of target composition | p′:a:b:c | Liₚ _{q}NiₓMn_{y}Co_{z}O₂ |
| CE1 | A1 | Ni_{0.167}Mn_{0.5}Co_{0.333} | Li_{1.143}Ni_{0.143}Mn_{0.429}Co_{0.285}O₂ | 1.143 | 1.167 | 1.126:0.147:0.429:0.298 | Li_{1.118} _{0.015}Ni_{0.146}Mn_{0.426}Co_{0.296}O₂ |
| EX1 | A2 | Ni_{0.167}Mn_{0.5}Co_{0.333} | Li_{1.067}Ni_{0.156}Mn_{0.467}Co_{0.311}O₂ | 1.067 | 1.120 | 1.049:0.161:0.466:0.325 | Li_{0.997} _{0.1}Ni_{0.153}Mn_{0.443}Co_{0.309}O₂ |
| EX2 | A3 | Ni_{0.167}Mn_{0.5}Co_{0.333} | Li_{1.05}Ni_{0.159}Mn_{0.475}Co_{0.316}O₂ | 1.05 | 1.103 | 1.013:0.167:0.484:0.336 | Li_{0.944} _{0.136}Ni_{0.156}Mn_{0.451}Co_{0.313}O₂ |
| CE2 | B1 | Ni_{0.2}Mn_{0.5}Co_{0.3} | Li_{1.13}Ni_{0.174}Mn_{0.435}Co_{0.261}O₂ | 1.13 | 1.187 | 1.155:0.163:0.430:0.251 | Li_{1.168} _{-0.023}Ni_{0.165}Mn_{0.435}Co_{0.254}O₂ |
| EX3 | B2 | Ni_{0.2}Mn_{0.5}Co_{0.3} | Li_{1.067}Ni_{0.187}Mn_{0.467}Co_{0.28}O₂ | 1.067 | 1.120 | 1.054:0.187:0.470:0.289 | Li_{1.01} _{0.084}Ni_{0.179}Mn_{0.45}Co_{0.277}O₂ |
| EX4 | B3 | Ni_{0.2}Mn_{0.5}Co_{0.3} | Li_{1.05}Ni_{0.19}Mn_{0.475}Co_{0.285}O₂ | 1.05 | 1.102 | 1.045:0.190:0.472:0.292 | Li_{0.998} _{0.091}Ni_{0.181}Mn_{0.451}Co_{0.279}O₂ |
| EX5 | B4 | Ni_{0.2}Mn_{0.5}Co_{0.3} | Li_{1.037}Ni_{0.193}Mn_{0.482}Co_{0.289}O₂ | 1.037 | 1.089 | 1.050:0.187:0.472:0.292 | Li_{1.003} _{0.09}Ni_{0.179}Mn_{0.451}Co_{0.279}O₂ |
| CE3 | C1 | Ni_{0.3}Mn_{0.5}Co_{0.2} | Li_{1.091}Ni_{0.273}Mn_{0.455}Co_{0.182}O₂ | 1.091 | 1.146 | 1.079:0.277:0.458:0.186 | Li_{1.073} _{0.011}Ni_{0.275}Mn_{0.455}Co_{0.185}O₂ |
| CE4 | C2 | Ni_{0.3}Mn_{0.5}Co_{0.2} | Li_{1.067}Ni_{0.28}Mn_{0.467}Co_{0.187}O₂ | 1.067 | 1.120 | 1.082:0.275:0.455:0.187 | Li_{1.078} _{0.008}Ni_{0.274}Mn_{0.454}Co_{0.186}O₂ |
| CE5 | C3 | Ni_{0.3}Mn_{0.5}Co_{0.2} | Li_{1.05}Ni_{0.285}Mn_{0.475}Co_{0.19}O₂ | 1.05 | 1.102 | 1.057:0.282:0.468:0.193 | Li_{1.038} _{0.035}Ni_{0.277}Mn_{0.46}Co_{0.19}O₂ |
| EX6 | C4 | Ni_{0.3}Mn_{0.5}Co_{0.2} | Li_{1.015}Ni_{0.296}Mn_{0.493}Co_{0.197}O₂ | 1.015 | 1.066 | 1.021:0.294:0.486:0.198 | Li_{0.985} _{0.071}Ni_{0.284}Mn_{0.469}Co_{0.191}O₂ |
| EX7 | C5 | Ni_{0.3}Mn_{0.5}Co_{0.2} | Li_{0.998}Ni_{0.301}Mn_{0.501}Co_{0.2}O₂ | 0.998 | 1.048 | 1.008:0.295:0.495:0.201 | Li_{0.964} _{0.087}Ni_{0.282}Mn_{0.474}Co_{0.19}O₂ |
| CE6 | D1 | Ni_{0.333}Mn_{0.5}Co_{0.167} | Li_{1.077}Ni_{0.307}Mn_{0.462}Co_{0.154}O₂ | 1.077 | 1.131 | 1.076:0.309:0.458:0.156 | Li_{1.078} _{-0.001}N_{i0.309}Mn_{0.459}Co_{0.156}O₂ |
| CE7 | D2 | Ni_{0.333}Mn_{0.5}Co_{0.167} | Li_{1.067}Ni_{0.311}Mn_{0.467}Co_{0.156}O₂ | 1.067 | 1.120 | 1.072:0.312:0.460:0.157 | Li_{1.07} _{0.003}Ni_{0.311}Mn_{0.459}Co_{0.157}O₂ |
| CE8 | D3 | Ni_{0.333}Mn_{0.5}Co_{0.167} | Li_{1.05}Ni_{0.316}Mn_{0.475}Co_{0.159}O₂ | 1.05 | 1.102 | 1.065:0.311:0.465:0.158 | Li_{1.059} _{0.01}Ni_{0.309}Mn_{0.463}Co_{0.157}O₂ |
| EX8 | D4 | Ni_{0.333}Mn_{0.5}Co_{0.167} | Li_{1.001}Ni_{0.333}Mn_{0.5}Co_{0.167}O₂ | 1.001 | 1.051 | 1.016:0.328:0.489:0.167 | Li_{0.984} _{0.062}Ni_{0.318}Mn_{0.474}Co_{0.162}O₂ |
| EX9 | D5 | Ni_{0.333}Mn_{0.5}Co_{0.167} | Li_{0.984}Ni_{0.338}Mn_{0.508}Co_{0.17}O₂ | 0.984 | 1.033 | 1.003:0.330:0.499:0.168 | Li_{0.964} _{0.078}Ni_{0.317}Mn_{0.479}Co_{0.161}O₂ |
| CE9 | E1 | Ni_{0.05}Mn_{0.5}Co_{0.45} | Li_{1.184}Ni_{0.041}Mn_{0.408}Co_{0.367}O₂ | 1.184 | 1.243 | 1.155:0.043:0.417:0.385 | Li_{1.137} _{0.031}Ni_{0.042}Mn_{0.41}Co_{0.379}O₂ |
| CE10 | E2 | Ni_{0.05}Mn_{0.5}Co_{0.45} | Li_{1.11}Ni_{0.045}Mn_{0.445}Co_{0.401}O₂ | 1.11 | 1.166 | 1.103:0.046:0.440:0.411 | Li_{1.053} _{0.09}Ni_{0.044}Mn_{0.42}Co_{0.393}O₂ |
| CE11 | F1 | Ni_{0.16}Mn_{0.4}Co_{0.44} | Li_{1.108}Ni_{0.143}Mn_{0.357}Co_{0.392}O₂ | 1.108 | 1.163 | 1.053:0.152:0.371:0.423 | Li_{1.025} _{0.054}Ni_{0.148}Mn_{0.361}Co_{0.412}O₂ |
| EX10 | F2 | Ni_{0.16}Mn_{0.4}Co_{0.44} | Li_{1.067}Ni_{0.149}Mn_{0.373}Co_{0.411}O₂ | 1.067 | 1.120 | 1.008:0.163:0.387:0.443 | Li_{0.957} _{0.1}Ni_{0.155}Mn_{0.368}Co_{0.421}O₂ |
| EX11 | F3 | Ni_{0.16}Mn_{0.4}Co_{0.44} | Li_{1.05}Ni_{0.152}Mn_{0.38}Co_{0.418}O₂ | 1.05 | 1.103 | 0.993:0.162:0.394:0.450 | Li_{0.936} _{0.115}Ni_{0.153}Mn_{0.371}Co_{0.424}O₂ |
| CE12 | G1 | Ni_{0.2}Mn_{0.6}Co_{0.2} | Li_{1.167}Ni_{0.167}Mn_{0.5}Co_{0.167}O₂ | 1.167 | 1.225 | 1.177:0.157:0.496:0.169 | Li_{1.182} _{-0.009}Ni_{0.158}Mn_{0.498}Co_{0.17}O₂ |
| EX12 | G2 | Ni_{0.2}Mn_{0.6}Co_{0.2} | Li_{1.121}Ni_{0.176}Mn_{0.527}Co_{0.176}O₂ | 1.121 | 1.177 | 1.075:0.185:0.550:0.190 | Li_{1.02} _{0.102}Ni_{0.176}Mn_{0.522}Co_{0.18}O₂ |
| CE13 | H1 | Ni_{0.4}Mn_{0.5}Co_{0.1} | Li_{1.046}Ni_{0.382}Mn_{0.477}Co_{0.095}O₂ | 1.046 | 1.098 | 1.049:0.362:0.492:0.097 | Li_{1.041} _{0.016}Ni_{0.359}Mn_{0.488}Co_{0.096}O₂ |
| EX13 | H2 | Ni_{0.4}Mn_{0.5}Co_{0.1} | Li_{0.98}Ni_{0.408}Mn_{0.51}Co_{0.102}O₂ | 0.98 | 1.029 | 0.966:0.395:0.532:0.107 | Li_{0.919} _{0.098}Ni_{0.376}Mn_{0.506}Co_{0.102}O₂ |
| EX14 | H3 | Ni_{0.4}Mn_{0.5}Co_{0.1} | Li_{0.953}Ni_{0.419}Mn_{0.524}Co_{0.105}O₂ | 0.953 | 1.001 | 0.943:0.403:0.545:0.110 | Li_{0.886} _{0.122}Ni_{0.378}Mn_{0.512}Co_{0.103}O₂ |
| CE14 | I1 | Ni_{0.3}Mn_{0.6}Co_{0.1} | Li_{1.13}Ni_{0.261}Mn_{0.522}Co_{0.087}O₂ | 1.13 | 1.187 | 1.151:0.249:0.513:0.087 | Li_{1.162} _{-0.019}Ni_{0.251}Mn_{0.518}Co_{0.088}O₂ |
| EX15 | I2 | Ni_{0.3}Mn_{0.6}Co_{0.1} | Li_{1.037}Ni_{0.289}Mn_{0.578}Co_{0.096}O₂ | 1.037 | 1.089 | 1.049:0.279:0.574:0.098 | Li_{1.00} _{0.094}Ni_{0.266}Mn_{0.547}Co_{0.093}O₂ |
| CE15 | J1 | Ni_{0.2}Mn_{0.7}Co_{0.1} | Li_{1.2}Ni_{0.16}Mn_{0.56}Co_{0.08}O₂ | 1.2 | 1.26 | 1.192:0.160:0.566:0.082 | Li_{1.185} _{0.011}Ni_{0.159}Mn_{0.563}Co_{0.082}O₂ |
| EX16 | J2 | Ni_{0.2}Mn_{0.7}Co_{0.1} | Li_{1.107}Ni_{0.179}Mn_{0.625}Co_{0.089}O₂ | 1.107 | 1.162 | 1.089:0.179:0.639:0.093 | Li_{1.017} _{0.132}Ni_{0.167}Mn_{0.597}Co_{0.087}O₂ |
| CE16 | K1 | Ni_{0.3}Mn_{0.4}Co_{0.3} | Li_{1.048}Ni_{0.286}Mn_{0.381}Co_{0.286}O₂ | 1.048 | 1.100 | 1.028:0.296:0.380:0.295 | Li_{1.022} _{0.014}Ni_{0.294}Mn_{0.378}CO_{0.293}O₂ |
| EX17 | K2 | Ni_{0.3}Mn_{0.4}Co_{0.3} | Li_{0.954}Ni_{0.314}Mn_{0.418}Co_{0.314}O₂ | 0.954 | 1.002 | 0.926:0.320:0.424:0.330 | Li_{0.871} _{0.119}Ni_{0.301}Mn_{0.399}CO_{0.31}O₂ |
| CE17 | L1 | Ni_{0.2}Mn_{0.4}Co_{0.4} | Li_{1.091}Ni_{0.182}Mn_{0.364}Co_{0.364}O₂ | 1.091 | 1.146 | 1.087:0.181:0.360:0.373 | Li_{1.085} _{0.004}Ni_{0.181}Mn_{0.359}CO_{0.372}O₂ |
| EX18 | L2 | Ni_{0.2}Mn_{0.4}Co_{0.4} | Li_{0.996}Ni_{0.201}Mn_{0.402}Co_{0.402}O₂ | 0.996 | 1.046 | 0.982:0.203:0.402:0.413 | Li_{0.928} _{0.111}Ni_{0.192}Mn_{0.38}Co_{0.39}O₂ |
| CE18 | M1 | Ni_{0.1}Mn_{0.4}Co_{0.5} | Li_{1.13}Ni_{0.087}Mn_{0.348}Co_{0.435}O₂ | 1.13 | 1.187 | 1.121:0.088:0.344:0.447 | Li_{1.117} _{0.007}Ni_{0.088}Mn_{0.343}Co_{0.445}O₂ |
| EX19 | M2 | Ni_{0.1}Mn_{0.4}Co_{0.5} | Li_{1.036}Ni_{0.096}Mn_{0.386}Co_{0.482}O₂ | 1.036 | 1.088 | 1.016:0.099:0.383:0.502 | Li_{0.956} _{0.119}Ni_{0.093}Mn_{0.36}Co_{0.472}O₂ |
| CE19 | N1 | Ni_{0.2}Mn_{0.3}Co_{0.5} | Li_{1.048}Ni_{0.19}Mn_{0.286}Co_{0.476}O₂ | 1.048 | 1.100 | 1.014:0.199:0.284:0.503 | Li_{1.00} _{0.028}Ni_{0.196}Mn_{0.28}Co_{0.496}O₂ |
| EX20 | N2 | Ni_{0.2}Mn_{0.3}Co_{0.5} | Li_{0.954}Ni_{0.209}Mn_{0.314}Co_{0.523}O₂ | 0.954 | 1.002 | 0.926:0.217:0.310:0.547 | Li_{0.873} _{0.114}Ni_{0.205}Mn_{0.292}Co_{0.516}O₂ |
| CE20 | O1 | Ni_{0.1}Mn_{0.3}Co_{0.6} | Li_{1.091}Ni_{0.091}Mn_{0.273}Co_{0.545}O₂ | 1.091 | 1.146 | 1.073:0.093:0.270:0.564 | Li_{1.065} _{0.015}Ni_{0.092}Mn_{0.268}Co_{0.56}O₂ |
| EX21 | O2 | Ni_{0.1}Mn_{0.3}Co_{0.6} | Li_{0.997}Ni_{0.1}Mn_{0.301}Co_{0.602}O₂ | 0.997 | 1.047 | 0.973:0.103:0.300:0.625 | Li_{0.915} _{0.119}Ni_{0.097}Mn_{0.282}Co_{0.588}O₂ |

TABLE 2
Electrochemical cell cycling data for Ex 1-21 and CE 1-20

| Example (Ex) | | | Co metal | Reversible | IRC (% of 1^{st} | |
|---|---|---|---|---|---|---|
| or Comp. | | Vacancy | ratio from | Capacity | Cycle charge | |
| Example (CE) | Sample | content (q) | ICP-OES | (mAh/g) | Capacity) | Fade |
| CE1 | A1 | 0.015 | 0.29781 | 247 | 22.5% | 0.008 |
| Ex1 | A2 | 0.100 | 0.32459 | 272 | 7.7% | 0.0337 |
| Ex2 | A3 | 0.136 | 0.33607 | 266 | 6.5% | 0.0333 |
| CE2 | B1 | −0.023 | 0.2511 | 246 | 22.0% | 0.0258 |
| EX3 | B2 | 0.084 | 0.28898 | 267 | 9.5% | 0.0292 |
| Ex4 | B3 | 0.091 | 0.29188 | 259 | 7.5% | 0.0304 |
| Ex5 | B4 | 0.090 | 0.29153 | 261 | 6.9% | 0.0537 |
| CE3 | C1 | 0.011 | 0.18605 | 228 | 22.7% | 0.0652 |
| CE4 | C2 | 0.008 | 0.18721 | 228 | 19.5% | 0.0246 |
| CE5 | C3 | 0.035 | 0.19289 | 235 | 14.5% | 0.0648 |
| Ex6 | C4 | 0.071 | 0.19808 | 237 | 10.7% | 0.0373 |
| Ex7 | C5 | 0.087 | 0.20106 | 232 | 9.8% | 0.0553 |
| CE6 | D1 | −0.001 | 0.15648 | 208 | 24.5% | 0.0047 |
| CE7 | D2 | 0.003 | 0.15707 | 212 | 22.4% | 0.0085 |
| CE8 | D3 | 0.010 | 0.15842 | 218 | 20.3% | 0.0137 |
| Ex8 | D4 | 0.062 | 0.16682 | 249 | 7.6% | 0.0029 |
| Ex9 | D5 | 0.078 | 0.16796 | 240 | 6.9% | 0.0424 |
| CE9 | E1 | 0.031 | 0.38504 | 206 | 37.0% | 0.1134 |
| CE10 | E2 | 0.090 | 0.41137 | 241 | 23.9% | 0.1206 |
| CE11 | F1 | 0.054 | 0.42347 | 234 | 22.5% | 0.0801 |
| EX10 | F2 | 0.100 | 0.44284 | 233 | 15.0% | 0.0769 |
| EX11 | F3 | 0.115 | 0.45021 | 233 | 13.2% | 0.1176 |
| CE12 | G1 | −0.009 | 0.16972 | 281 | 15.5% | 0.0218 |
| Ex12 | G2 | 0.102 | 0.18951 | 215 | 14.9% | 0.0211 |
| CE13 | H1 | 0.016 | 0.09739 | 235 | 15.7% | 0.05 |
| Ex13 | H2 | 0.098 | 0.10699 | 243 | 5.0% | 0.1318 |
| Ex14 | H3 | 0.122 | 0.1097 | 233 | 3.0% | 0.0376 |
| CE14 | I1 | −0.019 | 0.08715 | 240 | 23.5% | 0.0097 |
| Ex15 | I2 | 0.094 | 0.09772 | 259 | 7.3% | 0.0318 |
| CE15 | J1 | 0.011 | 0.08203 | 218 | 30.0% | 0.0448 |
| Ex16 | J2 | 0.132 | 0.09307 | 258 | 13.8% | 0.0683 |
| CE16 | K1 | 0.014 | 0.29511 | 226 | 24.0% | 0.0377 |
| Ex17 | K2 | 0.119 | 0.32955 | 228 | 10.4% | 0.0536 |
| CE17 | L1 | 0.004 | 0.37285 | 231 | 25.0% | 0.0515 |
| Ex18 | L2 | 0.111 | 0.41339 | 253 | 8.5% | 0.0507 |
| CE18 | M1 | 0.007 | 0.44726 | 218 | 32.0% | 0.1073 |
| EX19 | M2 | 0.119 | 0.50188 | 254 | 10.1% | 0.058 |
| CE19 | N1 | 0.028 | 0.5027 | 216 | 26.2% | 0.0968 |
| EX20 | N2 | 0.114 | 0.54675 | 235 | 8.2% | 0.0893 |
| CE20 | O1 | 0.015 | 0.56387 | 213 | 30.9% | 0.1469 |
| EX21 | O2 | 0.119 | 0.62493 | 233 | 7.6% | 0.0611 |

TABLE 3
Lattice constants (* denotes samples with impurity and only
the major phases are refined to get the lattice parameters).

| Example (Ex) or | | | | | |
|---|---|---|---|---|---|
| Comp. Example (CE) | Sample | a(Å) | error | c(Å) | error |
| CE1 | A1 | 2.8458 | 0.0001 | 14.214 | 0.001 |
| Ex1 | A2 | 2.8476 | 0.0001 | 14.232 | 0.001 |
| Ex2 | A3* | 2.8476 | 0.0001 | 14.223 | 0.001 |
| CE2 | B1 | 2.8481 | 0.0001 | 14.218 | 0.001 |
| EX3 | B2 | 2.8514 | 0.0001 | 14.238 | 0.001 |
| Ex4 | B3 | 2.8504 | 0.0001 | 14.236 | 0.001 |
| Ex5 | B4* | 2.8515 | 0.0002 | 14.237 | 0.001 |
| CE3 | C1 | 2.8597 | 0.0001 | 14.239 | 0.001 |
| CE4 | C2 | 2.8625 | 0.0001 | 14.252 | 0.001 |
| CE5 | C3 | 2.8635 | 0.0001 | 14.259 | 0.001 |
| Ex6 | C4 | 2.8625 | 0.0002 | 14.261 | 0.002 |
| Ex7 | C5* | 2.8637 | 0.0002 | 14.252 | 0.003 |
| CE6 | D1 | 2.8614 | 0.0001 | 14.248 | 0.001 |
| CE7 | D2 | 2.8631 | 0.0004 | 14.252 | 0.002 |
| CE8 | D3 | 2.8643 | 0.0001 | 14.257 | 0.001 |
| Ex8 | D4 | 2.8653 | 0.0007 | 14.270 | 0.003 |
| Ex9 | D5* | 2.8609 | 0.0005 | 14.259 | 0.003 |
| CE9 | E1 | 2.8346 | 0.0001 | 14.208 | 0.001 |
| CE10 | E2* | 2.8331 | 0.0001 | 14.198 | 0.001 |
| CE11 | F1 | 2.8477 | 0.0004 | 14.223 | 0.002 |
| Ex10 | F2 | 2.8445 | 0.0002 | 14.215 | 0.002 |
| Ex11 | F3 | 2.8462 | 0.0001 | 14.223 | 0.001 |
| CE12 | G1 | 2.8564 | 0.0001 | 14.258 | 0.001 |
| Ex12 | G2 | 2.8572 | 0.0002 | 14.256 | 0.001 |
| CE13 | H1 | 2.8702 | 0.0010 | 14.270 | 0.001 |
| Ex13 | H2* | 2.8762 | 0.0003 | 14.295 | 0.005 |
| Ex14 | H3* | 2.8811 | 0.0013 | 14.267 | 0.008 |
| CE14 | I1 | 2.8582 | 0.0003 | 14.244 | 0.001 |
| Ex15 | I2* | 2.8597 | 0.0002 | 14.279 | 0.003 |
| CE15 | J1 | 2.8522 | 0.0001 | 14.232 | 0.001 |
| Ex16 | J2* | 2.8513 | 0.0001 | 14.248 | 0.002 |
| CE16 | K1 | 2.8577 | 0.0001 | 14.230 | 0.001 |
| Ex17 | K2 | 2.8639 | 0.0005 | 14.263 | 0.002 |
| CE17 | L1 | 2.8453 | 0.0001 | 14.200 | 0.001 |
| Ex18 | L2 | 2.8496 | 0.0001 | 14.229 | 0.001 |
| CE18 | M1 | 2.8345 | 0.0004 | 14.173 | 0.002 |
| Ex19 | M2* | 2.8362 | 0.0002 | 14.201 | 0.002 |
| CE19 | N1 | 2.8423 | 0.0001 | 14.184 | 0.001 |
| Ex20 | N2* | 2.8439 | 0.0004 | 14.219 | 0.002 |
| CE20 | O1 | 2.8316 | 0.0001 | 14.155 | 0.001 |
| Ex21 | O2 | 2.8304 | 0.0001 | 14.192 | 0.001 |

### References for FIG. 5

1. Precursors of positive electrode materials of the present disclosure
2. Z Lu et al Electrochemical and Solid-State Letters, 4 (11) A191-A194 (2001)
3. J Jiang et al Journal of the Electrochemical Society 152 (9) A1879-A1889 (2005)
4. Arunkumar et al Chem Mater 2007, 19, 3067-3073
5. H Koga et al Journal of Power Sources 236 (2013) 250-258
6. H Deng et al Journal of the Electrochemical Society, 157 (7) A776-A781 (2010)
7. S. H. Kang et al J. Mater. Chem., 2007, 17, 2069-2077 2069
8. J.-H. Lim et al Journal of Power Sources 189 (2009) 571-575
9. D Mohanty et al Journal of Power Sources 229 (2013) 239-248
10. D. Kim et al Journal of The Electrochemical Society 160 (1) A31-A38 (2013)

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the numerous embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the numerous embodiments of the present disclosure. Furthermore, the particular features, structures, materials, or characteristics may be combined in any suitable manner in one or more embodiments.

While the specification has described in detail certain embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove.

Various exemplary embodiments have been described. These and other embodiments are within the scope of the following claims.

1. A cathode composition comprising a lithium transition metal oxide having the formula
Liₚ□_{q}NiₓMn_{y}Co_{z}O₂,
where □ represents assumed vacancy content, p+q+x+y+z=2, 0.06<q<0.15, 0.88<p<1.01; 0.1<x<0.45, 0.05<y<0.6, and 0.05<z<0.5;
wherein the lithium transition metal oxide has an O3 type structure; and
wherein the irreversible capacity, when the composition is tested using a Li metal foil as a counter electrode and a carbonate based electrolyte containing 1M LiPF6, is less than 10% between 2.0-4.8V vs Li using 10 mA/g at 30° C.

2. The cathode composition according to claim 1, wherein the lithium transition metal oxide is in the form of a single phase.

3. A cathode composition comprising a lithium transition metal oxide having the formula
Liₚ□_{q}NiₓMn_{y}Co_{z}O₂,
where □ represents an assumed vacancy content, p+q+x+y+z=2, 0.05<q<0.15, 0.8<p<1.02, 0.05<x<0.45, 0.05<y<0.6, 0.05<z<0.6, and 0.14<p*x<0.34; and
wherein the lithium transition metal oxide has an O3 type structure.

4. A cathode composition according to claim 3, wherein the lithium transition metal oxide is in the form of a single phase.

5. The cathode composition according to claim 1, further comprising a binder and a conductive diluent.

6. A lithium-ion battery comprising: an anode; a cathode comprising a cathode composition according to claim 1; and an electrolyte.

7. A method of making a lithium transition metal oxide cathode composition, the method comprising:
combining precursors having a formula (i) Ni_{x′}Mn_{y′}Co_{z′}CO₃; or (ii) Ni_{x′}Mn_{y′}Co_{z′}(OH)₂, where x′+y′+z′=1; and
heating the precursors to form the lithium transition metal oxide according to claim 1.

8. The cathode composition according to claim 3, further comprising a binder and a conductive diluent.

9. A lithium-ion battery comprising: an anode; a cathode comprising a cathode composition according to claim 3; and an electrolyte.

10. A method of making a lithium transition metal oxide cathode composition, the method comprising:
combining precursors having a formula (i) Ni_{x′}Mn_{y′}Co_{z′}CO₃; or (ii) Ni_{x′}Mn_{y′}Co_{z′}(OH)₂, where x′+y′+z′=1; and
heating the precursors to form the lithium transition metal oxide according to claim 3.
